(19) United States
(12) Patent Application Publication
(10) Pub. No.: US 2026/0017694 A1
(43) Pub. Date: Jan. 15, 2026

(54) APPRAISAL ENGINE(S) FOR PROPERTY VALUATION BASED ON COMPARABLE PROPERTIES

(71) Applicant: Quantarium Group, LLC, Bellevue, WA (US)

(72) Inventors: Andrei T. Aron, Woodinville, WA (US); Adrian Fanaru, Sammamish, WA (US); Petru Cociorva, Redmond, WA (US); Ioan Smintina, Kirkland, WA (US)

(21) Appl. No.: 18/771,296

(22) Filed: Jul. 12, 2024

(51) Int. Cl. G06Q 30/02; G06Q 30/0201; G06Q 50/16

(52) U.S. Cl. CPC G06Q 30/0278; G06Q 30/0206; G06Q 50/16

(57) ABSTRACT

Systems and methods herein provide an appraisal engine and its related functions. In an example, a method includes determining, by an appraisal engine, the target property and a corresponding a target specification which includes variables relating to features and/or characteristics of the target property. The appraisal engine may then determine comparable properties based on the target property and variables based on the target specification to use during an appraisal process. Based on the comparable properties and the variables, the appraisal engine may generate visual representations, each of which provides a comparison of the target property to the comparable properties for a respective variable. The appraisal engine may then determine an appraisal value of the target property based on the visual representations.

### TECHNICAL FIELD

Aspects of the disclosure are related to the field of computer software applications and services and, in particular, to appraisal engines for valuation of a target property based on comparable properties.

### BACKGROUND

Property appraisal is a fundamental practice universally employed to determine the value of real estate for various purposes, including sales, taxation, and financing. This process involves a detailed evaluation of a property by a licensed appraiser who considers factors such as location, condition, size, and market trends to provide an accurate estimate of its worth. Property appraisal is a common and essential step in real estate transactions, ensuring that both buyers and sellers have a clear understanding of a property's fair market value. This objective assessment helps facilitate negotiations, secure financing, and establish equitable sale prices, making it an indispensable tool in the real estate industry.

Under the conventional appraisal approach, appraisal of a target property typically begins with a comprehensive inspection, where the appraiser evaluates the property's physical characteristics, such as its size, layout, construction quality, and overall condition. Beyond the physical attributes, the appraiser also assesses the property's location, considering factors like neighborhood quality, proximity to amenities, and local market conditions. A critical component of the appraisal process is the comparison to similar properties, known as comparable properties or “comps.” The appraiser identifies recently sold properties in the vicinity that are similar in terms of size, age, style, and features. Using these comparable properties, the appraiser adjusts for differences and derives an appraisal value that reflects the target property's position within the local market. This method, known as the sales comparison approach, ensures that the appraisal is grounded in actual market activity, providing a reliable basis for determining a fair sale price.

Despite its widespread use and fundamental role in real estate transactions, the conventional appraisal process is not without its shortcomings. One significant limitation is its inherent subjectivity. Appraisers must exercise judgment when selecting comparable properties, often choosing only three out of many potential candidates. This selection process can introduce bias and variability, as different appraisers might select different comparable properties, leading to differing appraised values. Additionally, the appraisal process is time-intensive, as each comparable property must be meticulously analyzed and adjusted to reflect differences in features, condition, and other specifics relative to the target property. These adjustments require detailed knowledge and considerable effort, further contributing to the time and cost of the appraisal. Consequently, while appraisals aim to provide an accurate market value, the subjective nature and intensive labor involved can result in variations and delays that may affect the overall efficiency and reliability of the process.

Accordingly, there is a need for an appraisal engine, and its related functions, for generating an appraisal value for a target property based on a large pool comparable properties. As will be expanded on below, the appraisal engine may generate a value estimation (e.g., appraisal value) for a target property based on an aggregation of average sale prices for comparable properties over a range of similar features (e.g., variables).

### SUMMARY

Technology disclosed herein includes software applications and services that provide an appraisal engine, and its related functions. In an aspect, an appraisal engine may determine a target property for valuation. The appraisal engine may then determine comparable properties based on the target property for use in the valuation process. In some embodiments, the comparable properties may be determined based on a physical proximity and/or temporal proximity to the target property. Based on the target property, the appraisal engine may also determine variables to be used during the valuation process, which is also referred to herein as an appraisal process.

Once the comparable properties and the variables are determined, the appraisal engine may generate visual representations comparing the target property to the comparable properties. Each of the visual representations may correspond to one variable of the selected variables. For example, a visual representation comparing the general living area (GLA) of the target property to the comparable properties may be generated. Based on the visual representation, a value adjustment may be determined. The value adjustment may be an amount of value that should be adjusted based on the difference between the target property and the comparable properties. In some embodiments, the value adjustment may be based on an adjustment recommendation generated by the appraisal engine.

Once value adjustments are determined for each of the variables, such as based on a respective visual representation, the appraisal engine may generate an appraisal summary. The appraisal summary may allow for additional value adjustments to be made, such as based on features or characteristics unique to the target property and/or outside of the selected variables. Once all adjustments, including the value adjustments and the additional value adjustments, are made, the appraisal engine may finalize an overall appraisal value for the target property. In some embodiments, finalizing the overall appraisal value may include sending the overall appraisal value to a respective client device and/or updating respective documents, such as sales or marketing documents, with the overall appraisal value.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing an appraisal engine, according to an embodiment herein;

FIG. 2 illustrates an example operational scenario in which an appraisal engine is provided, according to an embodiment provided herein;

FIG. 3 illustrates a process for providing an appraisal engine and its related functions, according to an embodiment herein;

FIG. 4 illustrates an example map of properties for determining comparable properties, according to an embodiment herein;

FIG. 5 illustrates an example graphical user interface (GUI) including a visual representation, according to an embodiment herein;

FIG. 6 illustrates another example GUI including a visual representation, according to an embodiment herein;

FIG. 7 illustrates an example GUI of an appraisal summary, according to an embodiment herein; and

FIG. 8 shows an example client device suitable for providing an appraisal engine and related functions, according to an embodiment herein.

### DETAILED DESCRIPTION

Property appraisal is a fundamental practice universally employed to determine the value of real estate for various purposes, including sales, taxation, and financing. This process involves a detailed evaluation by a licensed appraiser who considers factors such as location, condition, size, and market trends to provide an accurate estimate of a property's value. Under the conventional appraisal approach, the process begins with a comprehensive analysis of a target property's physical characteristics or variables, such as size, layout, construction quality, and overall condition. Additionally, the appraiser may assess the property's location, considering neighborhood quality, proximity to amenities, and local market conditions.

A critical component of the conventional appraisal process is the comparison of similar properties, known as comparable properties or “comps,” to the target property. For this component, the appraiser identifies recently sold properties in the vicinity that are similar in terms of size, age, style, and features as the target property. Usually, three “similar” comparable properties are identified for use in the appraisal process. The appraiser then adjusts the sale price of each comparable property for differences (e.g., in characteristics, location, features) between the target property and a respective comparable property. The adjusted sale price for each of the comparable properties is then averaged to derive an appraisal value that reflects the target property's position within the local market.

Despite its widespread use, the conventional appraisal process has notable shortcomings. It is inherently subjective, as appraisers must estimate how to adjust the sale price of comparable properties based on various factors. For instance, while there might be 20 comparable properties available, only three are typically selected for the appraisal, introducing potential bias. The adjustments made to these comparable properties are based on variable factors such as size, condition, and location, which can be highly subjective and vary between appraisers. Moreover, each comparable property may be adjusted in isolation (e.g., individually), which can further introduce the appraiser's bias and preferences (e.g., preference for a particular style or feature).

Additionally, many of the variables used to adjust the sale price are often correlated, such as the number of bedrooms and the general living area (GLA) square footage. This correlation can lead to over-adjustment, as dependent variables are accounted for individually rather than in a combined manner. Consequently, it can be challenging to validate how an adjusted sale price for each comparable property was determined, undermining the transparency and reliability of the appraisal process. Moreover, the process is time-intensive, requiring detailed analysis and adjustments for each comparable property, which adds to the overall cost and duration of the appraisal.

The above identified issues with conventional appraisal approaches may result in inaccurate or unreliable appraisal values of a target property. As can be appreciated, inaccurate or unreliable appraisal estimates of a target property may have several negative consequences. For buyers, an overestimated value may lead to overpaying for a property, resulting in financial strain and potential difficulties in securing adequate financing. Conversely, sellers might undervalue their property based on a flawed appraisal, leading to significant financial losses. For lenders, inaccurate appraisals increase the risk of approving loans that exceed the property's true value, potentially resulting in higher default rates and financial instability. Additionally, incorrect appraisals can affect property tax assessments, leading to unfair tax burdens or insufficient public revenues. These inaccuracies can also erode trust in the real estate market, causing delays and disputes in transactions and undermining the overall confidence of stakeholders. In summary, unreliable appraisals can disrupt financial planning, distort market dynamics, and create broader economic repercussions. Accordingly, there is a need for improved techniques and systems for appraising a target property that provides accurate and reliable appraisal values in a time efficient manner.

To address at least the shortcomings of conventional appraisal approaches identified above, example appraisal engine(s) are provided herein. As will be described in greater detail below, the appraisal engine(s) provided herein determine an appraisal value of a target property by adjusting the target property based on the specifications of a pool of comparable properties. Unlike conventional approaches, the appraisal engine adjusts the target property based on comparable properties, not adjusting the comparable properties based on the target property. By adjusting the target property based on the comparable properties, the number of comparable properties used in the appraisal process can be increased over conventional approaches. As noted above, conventional appraisal approaches usually include three comparable properties to value a target property. Because under the conventional approach, each comparable property is adjusted based on the specifications of the target property, the number of comparable properties is limited, at least due to the time and resource constraints of the process. In contrast, because the appraisal engine adjusts the target to the comparable properties in aggregate, a larger number of comparable properties can be included in the appraisal process, such as 10 or more, 15 or more, 20 or more, or 25 or more comparable properties.

By including a larger number of comparable properties in the appraisal process, the appraisal engine provides several advantages over conventional approaches, such as enhanced accuracy and reliability of the valuation. For example, by including a broader set of comparable properties, the appraisal engine can capture a more comprehensive picture of the market, accounting for a wider range of property characteristics and market conditions. This may reduce the risk of selection bias and increase the likelihood that the chosen comparable properties truly reflect the target property's value. Additionally, a larger sample size allows for more nuanced adjustments, smoothing out anomalies that might arise from using only a few comparable properties. Overall, the appraisal engine, by incorporating more comparable properties, may enhance the robustness of the appraisal, providing a more accurate and defensible estimate that benefits buyers, sellers, lenders, and other stakeholders involved in the real estate transaction.

As can be appreciated, having an accurate and reliable appraisal estimate of a target property is crucial for several reasons. First, it ensures that buyers and sellers have a clear and fair understanding of the property's market value, facilitating informed decision-making and equitable negotiations. For buyers, a precise appraisal prevents overpaying, while for sellers, it helps in setting a realistic asking price, maximizing marketability without undervaluing the asset. Accurate appraisals are also essential for lenders, as they rely on these evaluations to determine the appropriate amount of financing to extend, thereby mitigating the risk of loan defaults. Moreover, reliable appraisals support tax assessments, ensuring that property taxes are based on true market value, which promotes fairness in tax obligations. Overall, an accurate and dependable appraisal underpins the integrity of real estate transactions, providing confidence and security to all parties involved.

In addition to providing a more accurate and reliable appraisal value, the appraisal engine allows for this valuation to occur in a time and resource efficient manner. As will be described in greater detail below, the appraisal engine may identify comparable properties to the target property and automatically generate a variety of visual representations based on specifications associated with each comparable property. Each of the visual representations may provide a comparison of the target property to the comparable properties for a respective variable. As used herein, a variable may include a feature type or characteristic of a respective property, such as a GLA, number of bedrooms, number of bathrooms, garage type, garage size, lot size, age, condition, and the like.

For each visual representation, an averaged sale price of the comparable properties may be provided along with an input field for providing an adjustment value based on differences between the target property and the comparable properties for this variable. For each of the visual representations, a user, such as a licensed appraiser, may provide an adjustment value that reflects the difference between the target property and comparable properties for a respective variable. Once adjustment values are provided for each variable or visual representation, the appraisal engine may generate an appraisal value for the target property. Since the user can visually analyze the differences between the target property and the comparable properties on a variable-by-variable approach, the valuation of the target property can be adjusted quickly and efficiently. Moreover, because the appraisal value for the target property is based on the value adjustments for each variable and the differences between the target property and the comparable properties, the appraisal value may be founded on market data, thereby providing a reliable and justified valuation of the target property.

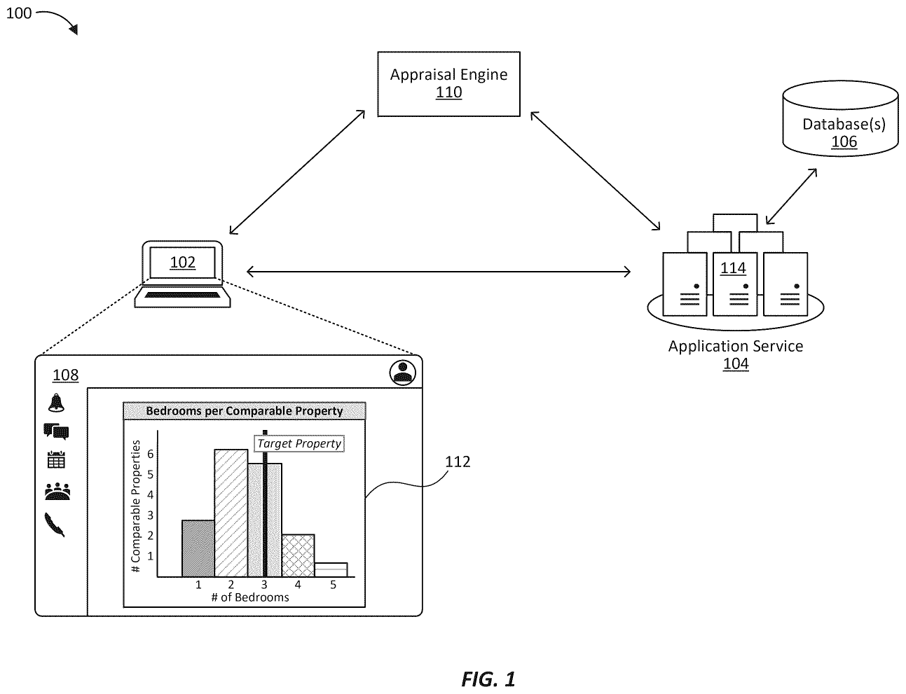

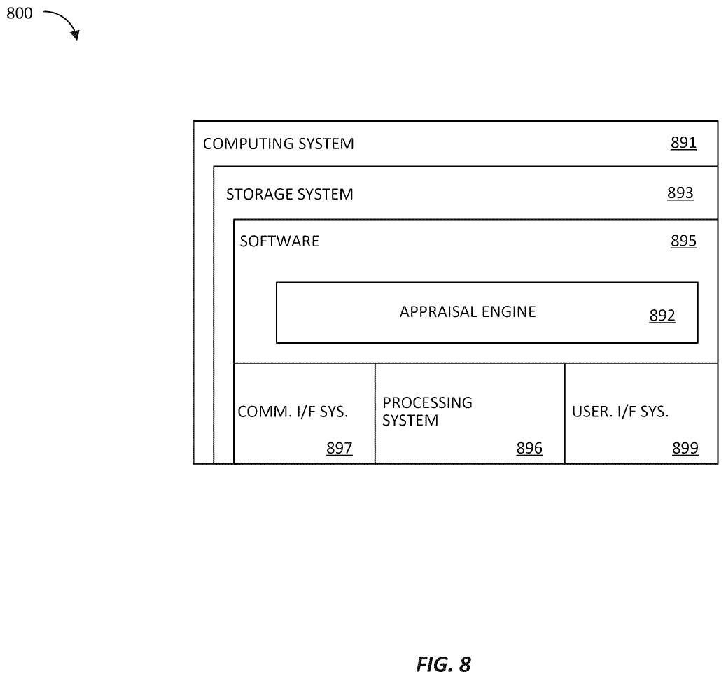

Turning now to FIG. 1, FIG. 1 illustrates an operational environment 100 for providing an appraisal engine, according to an embodiment herein. In particular, the operational environment 100 illustrates a client device 102 using an application service 104 for appraising target properties. To appraise target properties, the client device 102 may communicate with the application service 104 via one or more internets and intranets, the Internet, wired and wireless networks, local area networks (LANs), wide area networks (WANs), or any other type of network or combination thereof. Examples of the client device 102 may include personal computers, tablet computers, mobile phones, gaming consoles, wearable devices, Internet of Things (IoT) devices, and any other suitable devices, of which computing apparatus 891 in FIG. 8 is also broadly representative.

In the illustrated example, the application service 104 operates in a cloud-based environment. As such, the application service 104 employs one or more server computers 114 co-located with respect to each other or distributed across one or more data centers to deliver its functionalities and services. Example servers include web servers, application servers, virtual or physical servers, or any combination or variation thereof, of which computing apparatus 891 in FIG. 8 is broadly representative.

Broadly speaking, the application service 104 provides software application services to end points, such as the client device 102. In particular, the application service 104 may provide software application services involving property valuation. For example, the application service 104 may be a real estate application that aids appraisers in valuing or appraising properties. As noted above, valuation of property may be used for various purposes, including sales, taxation, and financing. To aid users, such as the client device 102, in property valuation, the application service 104 may provide one or more services for estimating appraisal values.

To interact with the application service 104, the client device 102 may load and execute software applications locally that interface with services and resources provided by the application service 104. The applications may be natively installed and executed applications, web-based applications that execute in the context of a local browser application, mobile applications, streaming applications, or any other suitable type of application. Example services and resources provided by the application service 104 include front-end servers, application servers, content storage services, authorization and authentication services, and the like.

As illustrated, the application service 104 may include an integration with the appraisal engine 110. In some embodiments, the appraisal engine 110 may be executed remotely by the application service 104 or a third party, while in other embodiments the appraisal engine 110 may be installed and executed locally on the client device 102. In still other embodiments, one or more functions of the appraisal engine 110, as described herein, may be installed and executed locally on the client device 102, while the remaining functions are integrated and executed remotely via the application service 104 or a third party. In an example, the application service 104 and/or the appraisal engine 110 may be a software-as-a7-service (SaaS) solution that provides one or more of the functions described herein to the client device 102.

To determine an appraisal value of a target property, the client device 102 may interact with the appraisal engine 110 via the application service 104. For example, the client device 102 may submit a request to appraisal engine 110 for an appraisal value of a target property. The target property may be a piece of real estate, such as a home for sale. It should be appreciated that while the following discussion involves the target property being a single family home, the provided description is equally applicable to any other type of real estate. As will be described in greater detail below, in some embodiments, the application service 104 may provide a map from which the client device 102 may select the target property for appraisal. For example, the client device 102 may select the target property in the map and request to generate an appraisal value for the target property. The request may be submitted to the appraisal engine 110.

Responsive to receiving the request for appraising the target property, the appraisal engine 110 may determine comparable properties to the target property. As will be described in greater detail below, the appraisal engine 110 may determine the comparable properties based on their physical proximity (e.g., within a 1 mile radius or same neighborhood) to the target property and/or their temporal proximity to the request (e.g., within the last 6 months, last year, last 2 years). In some embodiments, the comparable properties are identified from one or more databases 106. The databases 106 may be real estate databases that store records on real estate within a respective region or geographical location, such as a county assessor's office database, a multiple listing service (MLS) database, a property appraisal districts database, or a government database that collects and stores property information.

Once the comparable properties are identified, the appraisal engine may determine a variety of variables for which to compare the comparable properties and the target property. For example, based on a specification of the target property, the appraisal engine may determine that variables such as number of bedrooms, number of bathrooms, lot size, garage type, and GLA should be used for the comparison. As can be appreciated, there may be variables that are inapplicable to a given target property, such as lot size for a condo, that if included may not provide any benefit to the comparison. As such, the appraisal engine may analyze the specification of the target property to determine applicable variables for the comparison.

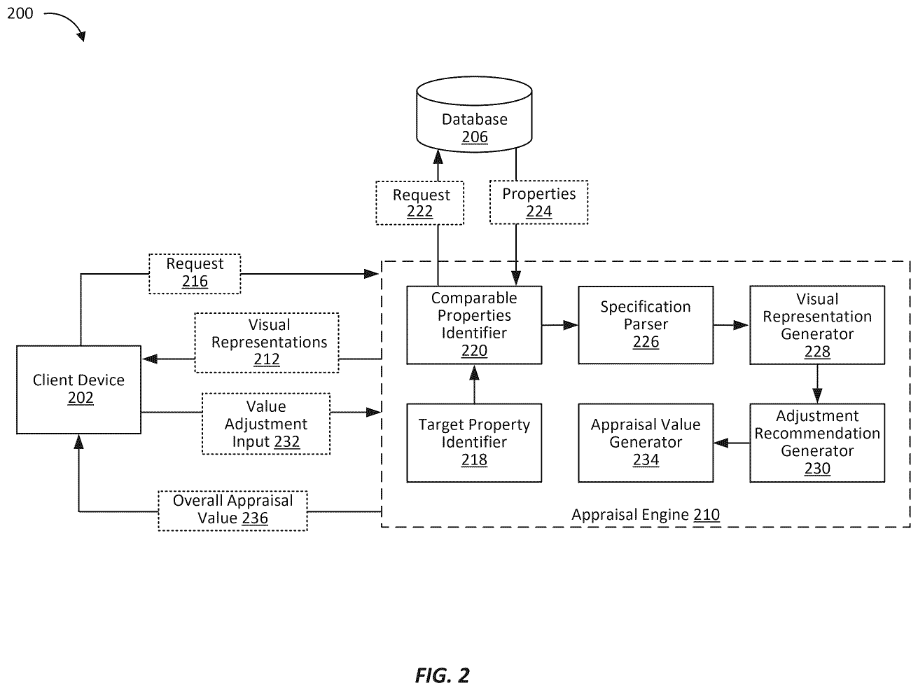

Based on the variables, the appraisal engine may generate visual representations, such as a visual representation 112. Each of the visual representations may correspond to a comparison between the comparable properties and the target property for a specific variable. As will be described in greater detail below with respect to FIGS. 2-6, the appraisal engine may generate a visual representation based on the specifications of the comparable properties. For example, from the specifications of the comparable properties, the appraisal engine may determine a specification value for a specific variable, such as number of bedrooms, for each of the comparable properties. Based on the specification value of the comparable properties, the appraisal engine may generate a visual representation that compares the specification values of the comparable properties to the respective specification value of the target property.

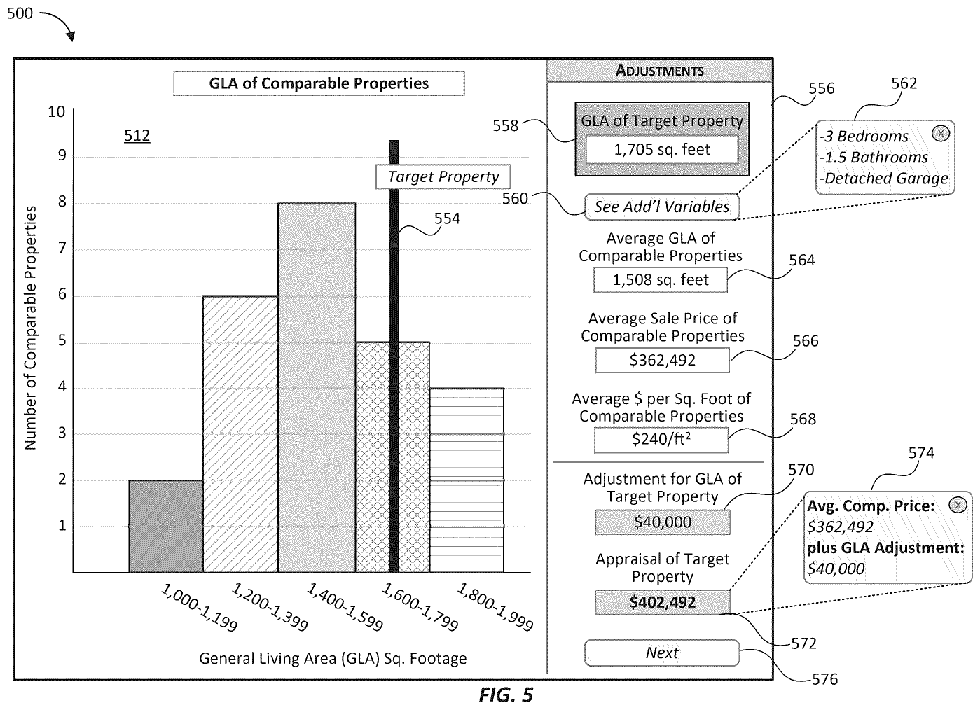

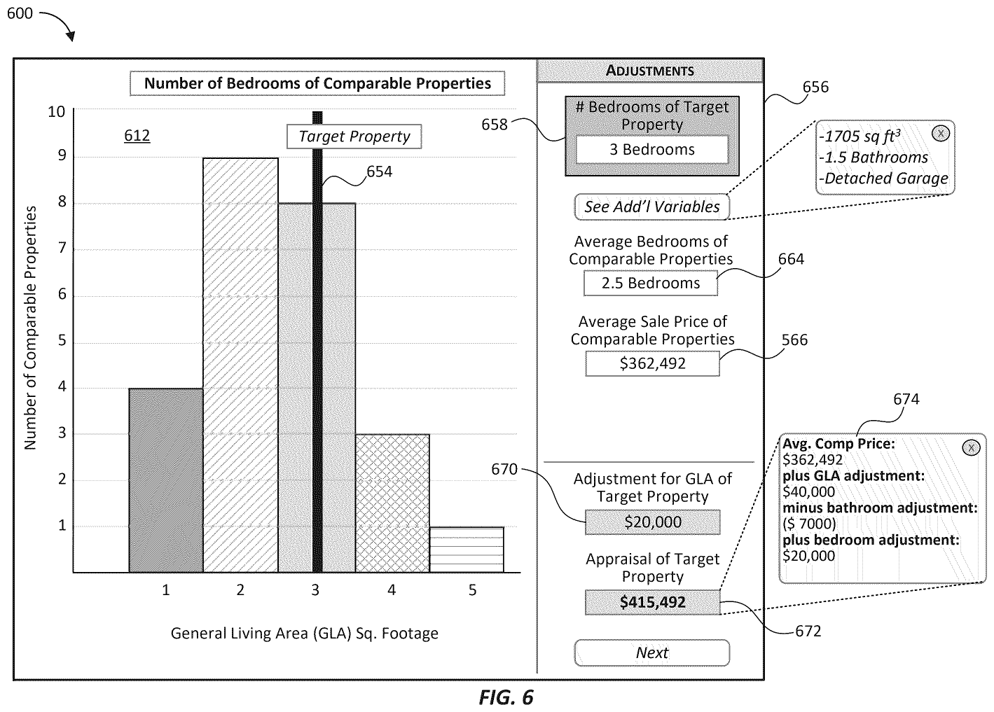

As illustrated, the visual representation 112 is provided to a user of the client device 102 via a user interface 108 of an application executing on the client device 102. The application may correspond to the application service 104. The user interface 108 may provide the visual representation 112 to the user such that the user can interact with the visual representation 112. As will be described in greater detail below with respect to FIGS. 5-6, the visual representation 112 may include an average sale price of the comparable properties. Additionally, the visual representation 112 may include an input field into which the user can provide a value adjustment. That is, the user may provide an amount to adjust the value of the target property for a given variable based on the visual representation 112.

As noted above, a visual representation may be generated for each of the variables identified based on the target property. As such, the client device 102 may interact with each of the visual representations, providing a value adjustment for each variable in a respective visual representation. Once a value adjustment is provided for each variable, the appraisal engine 110 may generate an appraisal value for the target property. In some embodiments, this may include aggregating all of the value adjustments received from the client device 102 with the averaged sale price of the comparable properties.

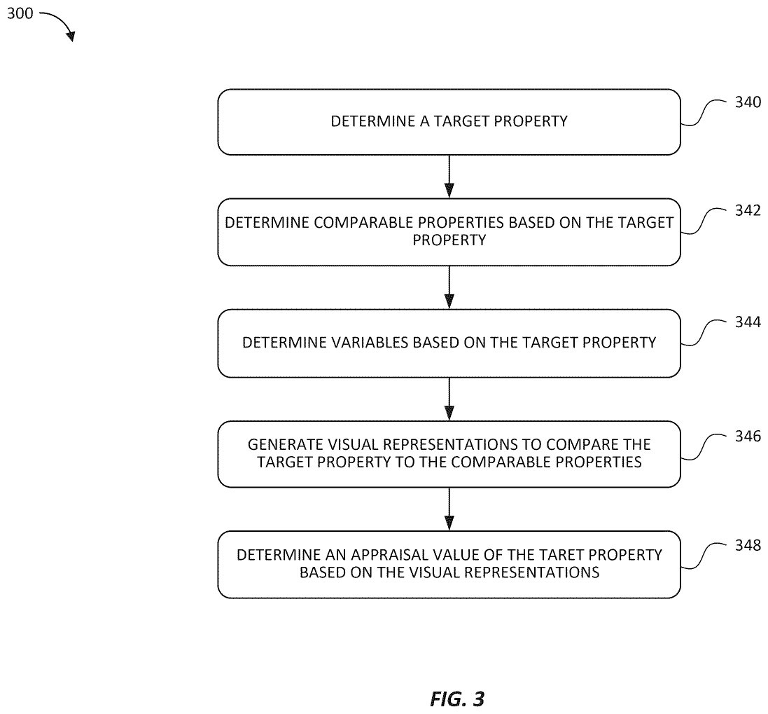

Turning now to FIG. 2, FIG. 2 illustrates an example operational scenario 200 in which an appraisal engine 210 is provided, according to an embodiment herein. For ease of illustration, FIG. 2 is described with respect to FIG. 3, which provides a process 300 for providing an appraisal engine and its related functions, such as the appraisal engine 210, according to an embodiment herein. Although FIG. 3 is described in relation to FIG. 2, it should be appreciated that the process 300 is equally applicable to the remaining Figures and components therein.

As illustrated, a client device 202, which may be the same or similar to the client device 102, may submit a request 216 to the appraisal engine 210, which may be the same or similar to the appraisal engine 110, to generate an appraisal value of a target property. In embodiments where the appraisal engine 210 is part of an application service, such as the application service 104, the request 216 may be transmitted to the appraisal engine 210 via the application service 104. Based on the request 216, the appraisal engine 210 may determine or identify the target property for valuation (340). In some embodiments, the appraisal engine 210 may include a target property identifier 218. As can be appreciated, the request 216 for appraisal of the target property includes or otherwise indicates the target property for valuation. For example, the request 216 may include a target specification of the target property an attachment, may include a link to the target specification, or otherwise direct the appraisal engine 210 as to where the target specification of the target property is stored. It should be appreciated that as used herein a specification may generally refer to a comprehensive document containing detailed information about a property, including its features, dimensions, materials, and other pertinent details essential for construction, renovation, or valuation purposes.

To identify the target property, the target property identifier 220 may analyze the request 216, including any attachments or links to determine a target specification for the target property. For example, the target property identifier 218 may fetch the target specification for the target property from a database, such as database 206, or may parse an attachment included in the request 216. The database 206 may be the same or similar to the database 106 such that the database 206 collects and/or stores real estate information, such as the target specification.

Based on the target property, the appraisal engine 110 may determine comparable properties for the valuation process (342). For example, the appraisal engine 110 may determine variables based on the target property (344). In particular, the appraisal engine 110 may determine variables based on the target specification. As noted above, these variables may include features or characteristics of the target property, such as GLA, lot size, number of bedrooms, number of bathrooms, and the like. The target specification may also include information such as location, neighborhoods, property type (e.g., single family home, condo), and the like. The appraisal engine 210 may use this information and/or the variables to determine comparable properties for the valuation process.

In some embodiments, the appraisal engine 210 may include a comparable properties identifier 220. The comparable properties identifier 220 may determine comparable properties based on the target property, such as identifying properties that recently sold near the target property. In some embodiments, the comparable properties identifier 220 may identify properties that are physically proximate to the target property, such as in the same zip code or neighborhood, that recently sold. In other embodiments, the comparable properties identifier 220 may identify properties that sold temporally proximate to the target property. That is, the comparable properties identifier 220 may identify properties that sold within a set time period from when the appraisal of the target property is requested. Examples include properties that sold in the last 6 months, the last year, or in the last two years from when the appraisal of the target property is being generated. In still other embodiments, the comparable properties identifier 220 may identify properties that are both physically and temporally proximate to the target property.

To identify properties to be included as comparable properties, the comparable properties identifier 220 may query the database 206. For example, the comparable properties identifier 220 may transmit a request 222 to the database 206 for specifications of properties that sold in the past two years and are physically proximate to the target property. Responsive to the request 222, the comparable properties identifier 220 may receive a listing of properties 224 that meet the requested criteria (e.g., physical proximity, temporal proximity).

The appraisal engine 210 may then filter the listing of properties 224 to determine similar properties to the target property. That is, the listing of properties 224 may be filtered based on the variables identified from the target specification such that only similar properties or properties having similar features or characteristics to the target property are selected as comparable properties. For example, the comparable properties identifier 220 may filter the listing of properties 224 by GLA such that only properties having similar GLAs (e.g., plus or minus 500 square feet) to the target property are included as comparable properties.

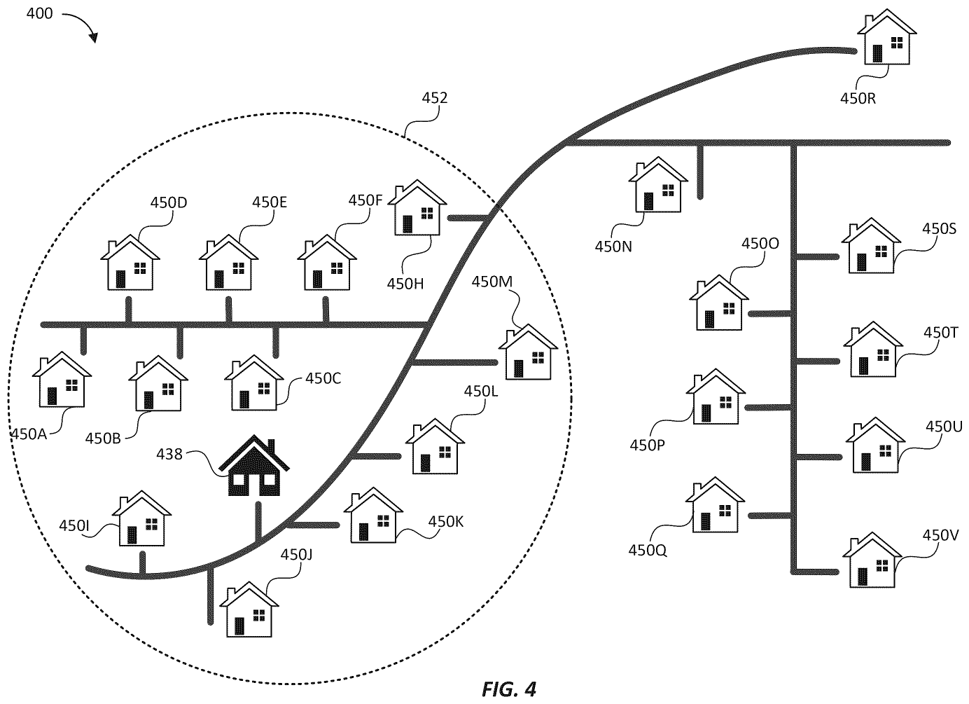

In some embodiments, the appraisal engine 210, or the related application service, may generate a map based on the listing of properties 224. Referring now to FIG. 4, an example map 400 of properties 450A-V is provided, according to an embodiment herein. The map 400 may be generated based on the listing of properties 224 received from the database 206. For example, the listing of properties 224 may include the properties 450A-V. It should be appreciated, that in some embodiments, the database 206 may be hosted by the application service and as such the application service may generate the map 400 responsive to the request 216. In similar embodiments, the application service may generate the map 400 of the properties 224 such that the client device 202 can select a target property, such as the target property 238, to request an appraisal value. Responsive to selecting the target property 238, the appraisal engine 210 may perform one or more of the functions described herein.

From the map 400, a user, such as the user of the client device 202, may select a subset of the properties 450A-V to include as comparable properties. As noted above, similar properties may be properties that are physical and/or temporally proximate to the target property 438. In some embodiments, the similar properties may also be properties that have similar features or characteristics to the target property. As illustrated, a user may delineate with an area 452 from which similar properties should be included. That is, any properties outside of the area 452, such as the properties 450N-V should be excluded as comparable properties, and the properties 450A-M inside of the area 452 may be used as comparable properties. In some embodiments, the 450A-M may be further filtered based on the variables to determined comparable properties.

Once the comparable properties are determined, then the appraisal engine 210 may generate visual representations to compare the target property 438 to the comparable properties, which for ease of discussion include properties 450A-M. To generate the visual representations, the appraisal engine 210 may first analyze the specifications corresponding to each of the comparable properties 450A-M to determine a specification value for each of the variables. In particular, the appraisal engine 210 may include a specification parser 226 that parses each specification of the comparable properties 450A-M to determine a respective specification value for each variable. For example, if the variables include GLA, a number of bedrooms, and a number of bathrooms, then the specification parser 226 may parse each specification to determine the GLA, the number of bedrooms, and the number of bathrooms of each comparable property 450A-M.

In some embodiments, based on the specification values identified from the specifications, the appraisal engine 210 may determine a grouping of specification ranges for each variable. For example, if the variable is GLA and the specification values for the comparable properties 450A-M range from 1,000 to 1,899, then the appraisal engine may group the specification values in specification ranges of 1,000-1,199, 1,200-1,399, 1,400-1,599, 1,600-1,799, and 1,800-1,999. In some embodiments, the specification ranges may be single values, such as for the variables of number of bedrooms and number of bathrooms. In such embodiments, the appraisal engine may group the specification values into specification ranges of 1 bedroom or bathroom, 2 bedroom or bathrooms, 3 bedroom or bathrooms, or 4 bedroom or bathrooms. In still other embodiments, the specification ranges may be non-numerical values, such as categories. For example, for garage type, the specification ranges may include the categories of “attached” and “detached.”

As noted above, based on the comparable properties, the appraisal engine 210 may generate visual representations for each variable. In particular, the appraisal engine 210 may include a visual representation generator 228 that may generate the visual representations. In some embodiments, the visual representations may be generated based on the specifications of each comparable properties, such as the specification values for each variable as determined from a respective specification.

Referring now to FIGS. 5-6, example visual representations are illustrated, according to embodiments herein. In particular, the FIGS. 5-6 illustrate example graphical user interfaces (GUIs) containing visual representations generated based on comparable properties, such as the comparable properties 450A-M for valuation of the target property 438. As shown, FIG. 5 includes a GUI 500 containing a visual representation 512. The visual representation 512 compares the comparable properties 450A-M to the target property 438 based on GLA, which is the respective variable of the visual representation 512.

As shown, the visual representation 512 includes the specification ranges 1,000-1,199, 1,200-1,399, 1,400-1,599, 1,600-1,799, and 1,800-1,899. For each of the specification ranges, the visual representation 512 indicates a number of comparable properties 450A-D that fall into each specification range. That is, according to the visual representation 512, two comparable properties have a GLA in the range of 1,000-1,199, six comparable properties have a GLA in the range of 1,200-1,399, eight comparable properties have a GLA in the range of 1,400-1,599, five comparable properties have a GLA in the range of 1,600-1,799, and four comparable properties have a GLA in the range of 1,800-1,899. As the visual representation 512 depicts a comparison between the comparable properties 450A-M and the target property 438, the visual representation 512 may include a marker 554. The marker 554 may indicate where a respective specification value for the target property 438, here GLA, compares to the specification values of the comparable properties 450A-M.

In some embodiments, the appraisal engine 210 may generate statistics for each visual representation. As illustrated, the GUI 500 may include a sidebar 556 that provides statistics on the target property 438 and/or the comparable properties 450A-M. That is, the sidebar 556 may include a specification value 558 of the target property 438 for the variable being displayed, here GLA. As shown, the specification value 558 indicates that the target property 438 has a GLA of 1,705 ft². The sidebar 456 may include an option 560 that allows a user, such as the user of the client device 202, to view the specification values of other variables for the target property 438. For example, upon selection of the option 560, a pop-up window 565 may be displayed. The pop-up window 565 may provide the specification values of the other variables for the target property 438. In some embodiments, the specification values for the target property 438 and/or the comparable properties 450A-M may be determined by the specification parser 226.

The sidebar 556 may also include an average specification value 562. The average specification value 562 may be the average of the specification values for a respective variable of the comparable properties 450A-M. The appraisal engine 210 may generate the average specification value 562. As can be appreciated, it may be advantageous for the user to compare the average specification value 564 with the specification value 558 of the target property 438 during the valuation process. In some embodiments, the average specification value 564 may be an average of the specification values of the comparable properties 450A-M, while in other embodiments the average specification value 564 may be a mean or median of the specification values for the comparable properties 450A-M.

The appraisal engine 210 may also generate an average sale price 566 of the comparable properties 450A-M. The average sale price 566 may be the average, mean, or median of the sale prices of the comparable properties 450A-M. In some embodiments, the sale prices of the comparable properties 450A-M may be adjusted, such to bring the prices into present-day dollars, to generate the average sale price 566. In other embodiments, the sale prices of the comparable properties 450A-M may be averaged (mean or median) and then adjusted to generate the average sale price 566. The appraisal engine 210 may generate the average sale price 566 based on the specifications for each of the comparable properties 450A-M.

In some embodiments, the sidebar 556 may include additional information, such as an average price per square foot statistic 568. The appraisal engine 210 may generate the statistic 568 based on the average specification value 564 and the average sale price 566. It should be appreciated that while the sidebar 556 only includes the average specification value 564, the average sale price 566, and the statistic 568, additional information may be included on the sidebar 556.

In addition to the statistics described above, the sidebar 556 may include a value adjustment 570 and a current appraisal value 572 of the target property 438. As noted above, when the visual representation 512 is generated, the visual representation, such as the visual representation 212 or 512, may be provided to the client device 202. The visual representation 512 may be displayed via the client device 202 to a user such that the user can determine a value adjustment for the target property 438 for each of the variables. As such, when viewing the GUI 500, the user may determine an appropriate value adjustment 570 to make for the target property 438 based on the visual representation 512. Here, the user may determine that the value adjustment is $40,000 since the target property 438 has a larger GLA than most of the comparable properties 450A-M. As such, the user may submit a value adjustment input 232 of $40,000 for the value adjustment 570, which may be an input field.

In some embodiments, the appraisal engine 210 may generate an adjustment recommendation for each variable based on the visual representations. That is, the appraisal engine 210 may determine the difference between the target specification value and an averaged specification value for the comparable properties 450A-M for a given variable. Based on the difference, the appraisal engine 510 may determine an adjustment recommendation. In such embodiments, the appraisal engine 510 may provide the adjustment recommendation on the GUI 500. For example, the adjustment recommendation may be provided in the value adjustment 570 input field as greyed text or otherwise indicated to be a recommendation. The user may use the adjustment recommendation to determine the value adjustment 570, including accepting the adjustment recommendation.

Based on the value adjustment 570, the appraisal engine 210 may generate an appraisal value 572 for the target property 438. In particular, the appraisal engine 210 may include an appraisal value generator 234 that generates the appraisal value 572 based on the value adjustments 570 received from the client device 202. In some embodiments, to generate the appraisal value 572 based on the value adjustments 570, the appraisal value generator 234 may determine the average sale price 566 of the comparable properties, in some embodiments adjusting the average sale price 566 to precent dollar value, and then sum the value adjustments 570. As noted above, in some embodiments an adjustment recommendation may be accepted as a respective value adjustments 570 for one or more of the variables.

As noted above, the appraisal engine 210 may generate multiple visual representations 212, each comparing the comparable properties 450A-M to the target property 438 for a given variable. For each of the visual representations 212 (e.g., 512), the client device 202 may provide a value adjustment 570. As such, in some embodiments, the appraisal value 572 may reflect the value adjustments 570 received at each previous visual representation 212 (e.g., 512). In such cases, a pop-out window 574 may be provided when a user selects or hovers over the appraisal value 572. As shown, the pop-out window 574 may indicate how the appraisal value 572 was determined, such as showing the average sale price of the comparable properties (e.g., Avg. Comp. Price) and any value adjustments made to this point in the appraisal process. In the illustrated example, the appraisal value 572 is $402,292 which is determined based on the average sale price of the comparable properties of $362,492 plus a value adjustment of $40,000 for GLA of the target property 438.

Once a value adjustment 570 is determined and input via the GUI 500, the user may select an option 576 to process to subsequent visual representation for another variable. For example, the user may select the option 576 and proceed to a visual representation for the variable of number of bedrooms. Referring now to FIG. 6, another example GUI 600 providing a visual representation 612 is illustrated. The visual representation 612 may be a visual representation that is generated by the appraisal engine 210 as part of the same appraisal process as the visual representation 512 As such, the visual representation 612 may depict a comparison of the comparable properties 450A-M to the target property 438 for another variable within the appraisal process. In the illustrated example, the visual representation 612 is generated for the variable of number of bathrooms.

Similar to the visual representation 512, the visual representation 612 includes a sidebar 656 containing various statistics relating to the respective variable comparison. As illustrated, the sidebar 656 includes a specification value 658 showing that the target property 438 has 3 bedrooms and an average specification value 664 indicated that the comparable properties 450A-M have an average of 2.5 bedrooms. The sidebar 656 also includes the average sale price 566 of the comparable properties 450A-M.

The sidebar 656 also includes an adjustment value 670 for the respective variable. As noted above, in some embodiments the appraisal engine 210 may generate an adjustment recommendation based on the average specification value 664 and the average sale price 566. As noted above, the user of the client device 202 may accept the adjustment recommendation as the adjustment value 670 for a given variable.

Once the adjustment value 670 is received, the appraisal engine 210 (e.g., appraisal value generator 234), may generate the appraisal value 672. The appraisal value 672 may be the generated valuation of the target property 438 including the value adjustments 570, 670 up until this point in the appraisal process. As shown, the user may select the appraisal value 672 to see how previous and current value adjustments 570, 670 were used to compute the appraisal value 672.

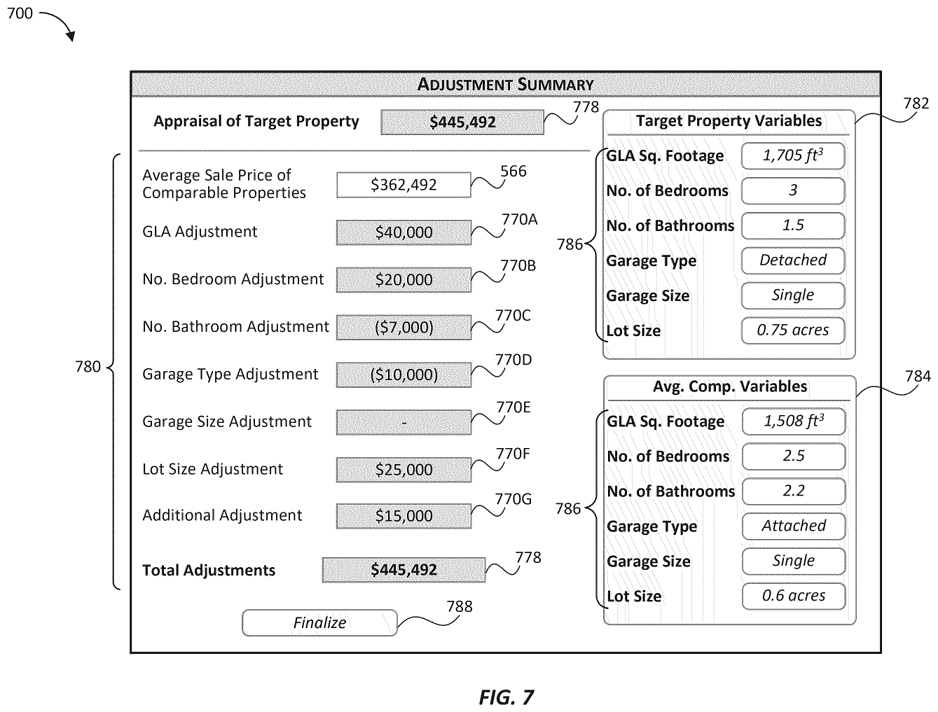

Once a value adjustment for each of the visual representations, and thus each variable, is received, the appraisal engine may generate an overall appraisal value for the target property 438. Referring now to FIG. 7, an example GUI 700 of an appraisal summary 780 is provided, according to an embodiment herein. As illustrated, the GUI 700 may include the appraisal summary 780 that shows how an overall appraisal value 778 is computed. In other words, the appraisal summary 780 provides each of the value adjustments 770A-G from which the overall appraisal value 778 is based on.

The value adjustments 770A and 770B may be the same or similar to the value adjustments 570 and 670, respectively. As such, the value adjustments 770A-B may be determined based on input from a client device or the adjustment recommendation generated based on a respective visual representation, here the visual representations 512 and 612. Similarly, the value adjustments 770C-F may be based on value adjustments received on a respective visual representation. In some embodiments, an additional value adjustment 770G may be included. The additional value adjustment 770G may be an option for a user to input any additional adjustments that should be made during the valuation process (e.g., not based on a visual representation). As can be appreciated, the valuation of property can extend beyond the mere specifications of the property. Instead, additional features or characteristics that are outside of the variables may be taken into account when determining the overall appraisal value 778. As such, the user may input additional adjustments to the valuation in the additional value adjustment 770G.

To further aid in the valuation process, the appraisal summary 780 may include a variable summary 782 for the target property 438 and a variable summary 784 for the comparable properties 450A-M. For each of the variable summaries 782 and 784, a summary of the respective specification values for each of the variables 786 used during the valuation process may be provided. That is, on the variable summary 782, the specification values for each of the variables 786 may be provided for the target property 438. And on the variable summary 784, an average specification value for each of the variables 786 may be provided for the comparable properties 450A-M. In some embodiments, additional information may be included as part of the appraisal summary 780, such as photos of the target property 438. As can be appreciated, this may allow the user additional information to reference when finalizing the overall appraisal value 778.

To finalize the overall appraisal value 778, an option 788 may be selected. Once selected, the appraisal engine 210, in particular the appraisal value generator 234 may finalize the overall appraisal value 778 and transmit the overall appraisal value 236, which may be the same or similar to the overall appraisal value 778, to the client device 202. In some embodiments, finalizing the overall appraisal value 236 (or 778) may include updating respective documents, such as a respective real estate property listing, with the valuation of the target property 438, or generating sales documentations based on the overall appraisal value 236 (or 778).

Referring to FIG. 8, FIG. 8 illustrates a computing apparatus 891 that may be used for providing an appraisal engine and related functions, as described herein. For example, the client device 102 or 202 may be or include the computing apparatus 891. As illustrated, the computing apparatus 891 includes a processing system 892 that includes a microprocessor and other circuitry that retrieves and executes software 895 from storage system 893. The processing system 892 may be implemented within a single processing device but may also be distributed across multiple processing devices or sub-systems that cooperate in executing program instructions. Examples of the processing system 892 include general purpose central processing units, graphical processing units, application specific processors, and logic devices, as well as any other type of processing device, combinations, or variations thereof.

The storage system 893 may comprise any computer-readable storage media or medium readable by processing system 892 and capable of storing software 895. The storage system 893 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 893 may also include computer readable communication media over which at least some of the software 895 may be communicated internally or externally. The storage system 893 may be implemented as a single storage device but may also be implemented across multiple storage devices or sub-systems co-located or distributed relative to each other. The storage system 893 may comprise additional elements, such as a controller capable of communicating with the processing system 892 or possibly other systems.

The software 895 (including appraisal engine process 696) may be implemented in program instructions and among other functions may, when executed by the processing system 892, direct the processing system 892 to operate as described with respect to the various operational scenarios, sequences, and processes illustrated herein. For example, the software 895 may include program instructions or an algorithm for implementing an appraisal engine and related functions, such as the process 300, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 895 may include additional processes, programs, or components, such as operating system software, virtualization software, or other application software. The software 895 may also comprise firmware or some other form of machine-readable processing instructions executable by the processing system 892.

In general, the software 895 may, when loaded into the processing system 892 and executed, transform a suitable apparatus, system, or device (of which computing apparatus 891 is representative) overall from a general-purpose computing system into a special-purpose computing system customized to generate features, functionality, and user experiences provided by the appraisal engine. Indeed, encoding the software 895 on the storage system 893 may transform the physical structure of the storage system 893. The specific transformation of the physical structure may depend on various factors in different implementations of this description. Examples of such factors may include, but are not limited to, the technology used to implement the storage media of the storage system 893 and whether the computer-storage media are characterized as primary or secondary storage, as well as other factors.

For example, if the computer readable storage media are implemented as semiconductor-based memory, the software 895 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 697 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 891 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing an appraisal engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; an appraisal engine comprising processor-executable instructions stored on the computer-readable storage medium; and one or more processors coupled to the computer-readable storage medium and configured to execute the processor-executable instructions, wherein the processor-executable instructions, when executed by the one or more processors, direct the computing apparatus, to at least: determine a target property, wherein the target property comprises a target specification comprising a plurality of variables; determine a plurality of comparable properties based on the target property; determine the plurality of variables based on the target specification; generate a plurality of visual representations, wherein each of the visual representations comprises a comparison of the target property and the plurality of comparable properties for a respective variable of the plurality of variables; and determine an appraisal value of the target property based on the plurality of visual representations.

Example 2 is the computing apparatus of any previous or subsequent Example, wherein the processor-executable instructions to determine the appraisal value of the target property based on the plurality of visual representations, when executed by the one or more processors, further direct the computing apparatus to: determine an average sale value for the plurality of comparable properties; determine a value adjustment for each of the plurality of variables based on a respective visual representation; and generate the appraisal value of the target property based on the value adjustment for each of the plurality of variables.

Example 3 is the computing apparatus of any previous or subsequent Example, wherein: the processor-executable instructions, when executed by the one or more processors, further direct the computing apparatus to: generate an adjustment recommendation for at least one of the plurality of variables based on a respective visual representation of the plurality of visual representations; receive, from a client device, a value adjustment for at least one variable of the plurality of variables based on a respective visual representation; and wherein the processor-executable instructions to determine the appraisal value of the target property based on the plurality of visual representations, when executed by the one or more processors, further direct the computing apparatus to: determine the appraisal value of the target property based on the adjustment recommendation and the value adjustment.

Example 4 is the computing apparatus of any previous or subsequent Example, wherein the processor-executable instructions to generate the plurality of visual representations, when executed by the one or more processors, further direct the computing apparatus to: determine a first variable of the plurality of variables; determine a specification value corresponding to the first variable for each of the plurality of comparable properties; and generate a first visual representation based on the specifications of the plurality of comparable properties, wherein the first visual representation indicates a number of comparable properties comprising similar specifications for the first variable.

Example 5 is the computing apparatus of any previous or subsequent Example, wherein the processor-executable instructions to generate the plurality of visual representations, when executed by the one or more processors, further direct the computing apparatus to: determine a plurality of specifications, wherein each of the plurality of specifications correspond to a respective comparable property of the plurality of comparable properties; parse each of the plurality of specifications based on the plurality of variables; determine a specification range for each of the plurality of variables based on parsing each of the plurality of specifications; and generate the plurality of visual representations based on a respective specification range, wherein each of the plurality of visual representations corresponds to a respective specification of the plurality of specifications.

Example 6 is the computing apparatus of any previous or subsequent Example, wherein the processor-executable instructions to determine the plurality of comparable properties, when executed by the one or more processors, further direct the computing apparatus to: determine a listing of properties comprising physical proximity to the target property; determining a subset of properties within the listing of properties comprising temporal proximity to the target property; and filtering, by the appraisal engine, the subset of properties to determine the plurality of comparable properties based on the plurality of variables.

Example 7 is a method for estimating an appraisal value of a target property based on a plurality of comparable properties, the method comprising: determining, by an appraisal engine, the target property, wherein the target property comprises a target specification comprising a plurality of variables; determining, by the appraisal engine, the plurality of comparable properties based on the target property; determining, by the appraisal engine, a plurality of variables based on the target specification; generating, by the appraisal engine, a plurality of visual representations, wherein each of the visual representations comprises a comparison of the target property and the plurality of comparable properties for a respective variable of the plurality of variables; and determining, by the appraisal engine, the appraisal value of the target property based on the plurality of visual representations.

Example 8 is the method of any previous or subsequent Example, wherein determining, by the appraisal engine, the appraisal value of the target property comprises: determining, by the appraisal engine, an average sale value for the plurality of comparable properties; determining, by the appraisal engine, a value adjustment for each of the plurality of variables based on a respective visual representation; and generating, by the appraisal engine, the appraisal value of the target property based on the value adjustment for each of the plurality of variables.

Example 9 is the method of any previous or subsequent Example, wherein: the method further comprising generating, by the appraisal engine, an adjustment recommendation for each of the plurality of variables based on the plurality of visual representations; and determining, by the appraisal engine, the appraisal value of the target property based on the plurality of visual representations comprises determining, by the appraisal engine, the appraisal value of the target property based on at least one adjustment recommendation for a respective variable of the plurality of variables.

Example 10 is the method of any previous or subsequent Example, wherein generating, by the appraisal engine, the plurality of visual representations comprises: determining, by the appraisal engine, a first variable of the plurality of variables; determining, by the appraisal engine, a specification value corresponding to the first variable for each of the plurality of comparable properties; and generating, by the appraisal engine, a first visual representation based on the specifications of the plurality of comparable properties, wherein the first visual representation indicates a number of comparable properties comprising similar specifications for the first variable.

Example 11 is the method of any previous or subsequent Example, wherein generating, by the appraisal engine, the plurality of visual representations comprises: requesting, by the appraisal engine, a plurality of specifications from a property database, wherein each of the plurality of specifications correspond to a respective comparable property of the plurality of comparable properties; parsing, by the appraisal engine, each of the plurality of specifications based on the plurality of variables; determining, by the appraisal engine, a specification range for each of the plurality of variables based on parsing each of the plurality of specifications; and generating, by the appraisal engine, the plurality of visual representations based on a respective specification range, wherein each of the plurality of visual representations corresponds to a respective specification of the plurality of specifications.

Example 12 is the method of any previous or subsequent Example, wherein determining, by the appraisal engine, the plurality of comparable properties comprises: determining, by the appraisal engine, a listing of properties comprising physical proximity to the target property; and filtering, by the appraisal engine, the listing of properties to determine the plurality of comparable properties based on the plurality of variables.

Example 13 is the method of any previous or subsequent Example, wherein determining, by the appraisal engine, the appraisal value of the target property comprises: receiving, from a client device, a value adjustment for each of the plurality of variables based on a respective visual representation by the appraisal engine; and determining, by the appraisal engine, the appraisal value of the target property based on the value adjustment for each of the plurality of variables.

Example 14 is the method of any previous or subsequent Example, wherein the plurality of visual representations comprises a plurality of histogram, each of the plurality of visual representations corresponding to a respective histogram visually representing a respective variable of the plurality of variables for each of the comparable properties.

Example 15 is a computer readable storage media comprising processor-executable instructions configured to cause one or more processors to: determine, by an appraisal engine, a target property, wherein the target property comprises a target specification comprising a plurality of variables; determine, by the appraisal engine, a plurality of comparable properties based on the target property; determine, by the appraisal engine, the plurality of variables based on the target specification; generate, by the appraisal engine, a plurality of visual representations, wherein each of the visual representations comprises a comparison of the target property and the plurality of comparable properties for a respective variable of the plurality of variables; and determine, by the appraisal engine, an appraisal value of the target property based on the plurality of visual representations.

Example 16 is the computer readable storage media of any previous or subsequent Example, wherein the processor-executable instructions to determine, by the appraisal engine, the appraisal value of the target property cause the one or more processors to further execute processor-executable instructions stored in the computer readable storage media to: determine, by the appraisal engine, an average sale value of the plurality of comparable properties; receive, by the appraisal engine, a value adjustment for each of the plurality of variables based on a respective visual representation; and generate, by the appraisal engine, the appraisal value based on the average sale value of the plurality of comparable properties and the value adjustment for each of the plurality of variables.

Example 17 is the computer readable storage media of any previous or subsequent Example, wherein the processor-executable instructions to generate, by the appraisal engine, the plurality of visual representations cause the one or more processors to further execute processor-executable instructions stored in the computer readable storage media to: determine, by the appraisal engine, a first variable of the plurality of variables; determine, by the appraisal engine, a specification value corresponding to the first variable for each of the plurality of comparable properties; and generate, by the appraisal engine, a first visual representation based on the specifications of the plurality of comparable properties, wherein the first visual representation indicates a number of comparable properties comprising similar specifications for the first variable.

Example 18 is the computer readable storage media of any previous or subsequent Example, wherein the processor-executable instructions to generate, by the appraisal engine, the plurality of visual representations cause the one or more processors to further execute processor-executable instructions stored in the computer readable storage media to: determine, by the appraisal engine, a plurality of specifications, wherein each of the plurality of specifications correspond to a respective comparable property of the plurality of comparable properties; determine, by the appraisal engine, a specification range for each of the plurality of variables based on each of the plurality of specifications; and generate, by the appraisal engine, the plurality of visual representations based on a respective specification range, wherein each of the plurality of visual representations corresponds to a respective specification of the plurality of specifications.

Example 19 is the computer readable storage media of any previous or subsequent Example, wherein: the processor-executable instructions cause the one or more processors to further execute processor-executable instructions stored in the computer readable storage media to: generate, by the appraisal engine, an adjustment recommendation for each of the plurality of variables based on the plurality of visual representations; and receive, from a client device, a value adjustment for a first variable of the plurality of variables based on a respective visual representation by the appraisal engine; and the processor-executable instructions to determine, by the appraisal engine, the appraisal value of the target property based on the plurality of visual representations cause the one or more processors to further execute processor-executable instructions stored in the computer readable storage media to: determine, by the appraisal engine, the appraisal value of the target property based on at least one adjustment recommendation for a respective variable of the plurality of variables and the value adjustment from the client device.

Example 20 is the computer readable storage media of any previous or subsequent Example, wherein the processor-executable instructions to determine, by the appraisal engine, the plurality of comparable properties based on the target property cause the one or more processors to further execute processor-executable instructions stored in the computer readable storage media to: determine, by the appraisal engine, a listing of properties comprising physical proximity to the target property; and filter, by the appraisal engine, the listing of properties based on the plurality of variables to determine the plurality of comparable properties.

1. A computing apparatus comprising:
a non-transitory computer-readable storage medium;
an appraisal engine comprising processor-executable instructions stored on the non-transitory computer-readable storage medium and configured to determine an appraisal value of a target property; and
one or more processors coupled to the non-transitory computer-readable storage medium and configured to execute the processor-executable instructions, wherein the processor-executable instructions, when executed by the one or more processors, direct the computing apparatus, to at least:
determine the target property, wherein the target property comprises a target specification comprising a plurality of variables;
determine a plurality of comparable properties based on the target property;
parse the target specification to identity the plurality of variables based on the target specification;
generate a plurality of visual representations based on the comparable properties and the target property, wherein each of the visual representations comprises a comparison of the target property and the plurality of comparable properties for a respective variable of the plurality of variables; and
compute the appraisal value of the target property based on the plurality of visual representations.

2. The computing apparatus of claim 1, wherein the processor-executable instructions to compute the appraisal value of the target property based on the plurality of visual representations, when executed by the one or more processors, further direct the computing apparatus to:
determine an average sale value for the plurality of comparable properties;
determine a value adjustment for each of the plurality of variables based on a respective visual representation; and
generate the appraisal value of the target property based on the value adjustment for each of the plurality of variables.

3. The computing apparatus of claim 1, wherein:
the processor-executable instructions, when executed by the one or more processors, further direct the computing apparatus to:
generate an adjustment recommendation for at least one of the plurality of variables based on a respective visual representation of the plurality of visual representations;
receive, from a client device, a value adjustment for at least one variable of the plurality of variables based on a respective visual representation; and
wherein the processor-executable instructions to determine the appraisal value of the target property based on the plurality of visual representations, when executed by the one or more processors, further direct the computing apparatus to:
determine the appraisal value of the target property based on the adjustment recommendation and the value adjustment.

4. The computing apparatus of claim 1, wherein the processor-executable instructions to generate the plurality of visual representations, when executed by the one or more processors, further direct the computing apparatus to:
determine a first variable of the plurality of variables;
determine a specification value corresponding to the first variable for each of the plurality of comparable properties; and
generate a first visual representation based on the specifications of the plurality of comparable properties, wherein the first visual representation indicates a number of comparable properties comprising similar specifications for the first variable.

5. The computing apparatus of claim 1, wherein the processor-executable instructions to generate the plurality of visual representations, when executed by the one or more processors, further direct the computing apparatus to:
determine a plurality of specifications, wherein each of the plurality of specifications correspond to a respective comparable property of the plurality of comparable properties;
parse each of the plurality of specifications based on the plurality of variables;
determine a specification range for each of the plurality of variables based on parsing each of the plurality of specifications; and
generate the plurality of visual representations based on a respective specification range, wherein each of the plurality of visual representations corresponds to a respective specification of the plurality of specifications.

6. The computing apparatus of claim 1, wherein the processor-executable instructions to determine the plurality of comparable properties, when executed by the one or more processors, further direct the computing apparatus to:
determine a listing of properties comprising physical proximity to the target property;
determining a subset of properties within the listing of properties comprising temporal proximity to the target property; and
filtering, by the appraisal engine, the subset of properties to determine the plurality of comparable properties based on the plurality of variables.

7. A method for estimating an appraisal value of a target property based on a plurality of comparable properties, the method comprising:
determining, by an appraisal engine comprising processor-executable instructions stored on a non-transitory computer-readable storage medium, the target property, wherein the target property comprises a target specification comprising a plurality of variables;
determining, by the appraisal engine, the plurality of comparable properties based on the target property;
parsing, by the appraisal engine, the target specification to identify a plurality of variables based on the target specification;
generating, by the appraisal engine, a plurality of visual representations based on the comparable properties and the target property, wherein each of the visual representations comprises a comparison of the target property and the plurality of comparable properties for a respective variable of the plurality of variables; and
computing, by the appraisal engine, the appraisal value of the target property based on the plurality of visual representations.

8. The method of claim 7, wherein computing, by the appraisal engine, the appraisal value of the target property comprises:
determining, by the appraisal engine, an average sale value for the plurality of comparable properties;
determining, by the appraisal engine, a value adjustment for each of the plurality of variables based on a respective visual representation; and
generating, by the appraisal engine, the appraisal value of the target property based on the value adjustment for each of the plurality of variables.

9. The method of claim 7, wherein:
the method further comprising generating, by the appraisal engine, an adjustment recommendation for each of the plurality of variables based on the plurality of visual representations; and
computing, by the appraisal engine, the appraisal value of the target property based on the plurality of visual representations comprises determining, by the appraisal engine, the appraisal value of the target property based on at least one adjustment recommendation for a respective variable of the plurality of variables.

10. The method of claim 7, wherein generating, by the appraisal engine, the plurality of visual representations comprises:
determining, by the appraisal engine, a first variable of the plurality of variables;
determining, by the appraisal engine, a specification value corresponding to the first variable for each of the plurality of comparable properties; and
generating, by the appraisal engine, a first visual representation based on the specifications of the plurality of comparable properties, wherein the first visual representation indicates a number of comparable properties comprising similar specifications for the first variable.

11. The method of claim 7, wherein generating, by the appraisal engine, the plurality of visual representations comprises:
requesting, by the appraisal engine, a plurality of specifications from a property database, wherein each of the plurality of specifications correspond to a respective comparable property of the plurality of comparable properties;
parsing, by the appraisal engine, each of the plurality of specifications based on the plurality of variables;
determining, by the appraisal engine, a specification range for each of the plurality of variables based on parsing each of the plurality of specifications; and
generating, by the appraisal engine, the plurality of visual representations based on a respective specification range, wherein each of the plurality of visual representations corresponds to a respective specification of the plurality of specifications.

12. The method of claim 7, wherein determining, by the appraisal engine, the plurality of comparable properties comprises:
determining, by the appraisal engine, a listing of properties comprising physical proximity to the target property; and
filtering, by the appraisal engine, the listing of properties to determine the plurality of comparable properties based on the plurality of variables.

13. The method of claim 7, wherein determining, by the appraisal engine, the appraisal value of the target property comprises:
receiving, from a client device, a value adjustment for each of the plurality of variables based on a respective visual representation by the appraisal engine; and
determining, by the appraisal engine, the appraisal value of the target property based on the value adjustment for each of the plurality of variables.

14. The method of claim 7, wherein the plurality of visual representations comprises a plurality of histogram, each of the plurality of visual representations corresponding to a respective histogram visually representing a respective variable of the plurality of variables for each of the comparable properties.

15. A non-transitory computer readable storage media comprising processor-executable instructions configured to cause one or more processors to:
determine, by an appraisal engine configured to determine an appraisal value of a target property, the target property, wherein the target property comprises a target specification comprising a plurality of variables;
determine, by the appraisal engine, a plurality of comparable properties based on the target property;
parse, by the appraisal engine, the target specification to identify the plurality of variables based on the target specification;
generate, by the appraisal engine, a plurality of visual representations based on the comparable properties and the target property, wherein each of the visual representations comprises a comparison of the target property and the plurality of comparable properties for a respective variable of the plurality of variables; and
compute, by the appraisal engine, the appraisal value of the target property based on the plurality of visual representations.

16. The non-transitory computer readable storage media of claim 15, wherein the processor-executable instructions to compute, by the appraisal engine, the appraisal value of the target property cause the one or more processors to further execute processor-executable instructions stored in the non-transitory computer readable storage media to:
determine, by the appraisal engine, an average sale value of the plurality of comparable properties;
receive, by the appraisal engine, a value adjustment for each of the plurality of variables based on a respective visual representation; and
generate, by the appraisal engine, the appraisal value based on the average sale value of the plurality of comparable properties and the value adjustment for each of the plurality of variables.

17. The non-transitory computer readable storage media of claim 15, wherein the processor-executable instructions to generate, by the appraisal engine, the plurality of visual representations cause the one or more processors to further execute processor-executable instructions stored in the non-transitory computer readable storage media to:
determine, by the appraisal engine, a first variable of the plurality of variables;
determine, by the appraisal engine, a specification value corresponding to the first variable for each of the plurality of comparable properties; and
generate, by the appraisal engine, a first visual representation based on the specifications of the plurality of comparable properties, wherein the first visual representation indicates a number of comparable properties comprising similar specifications for the first variable.

18. The non-transitory computer readable storage media of claim 15, wherein the processor-executable instructions to generate, by the appraisal engine, the plurality of visual representations cause the one or more processors to further execute processor-executable instructions stored in the non-transitory computer readable storage media to:
determine, by the appraisal engine, a plurality of specifications, wherein each of the plurality of specifications correspond to a respective comparable property of the plurality of comparable properties;
determine, by the appraisal engine, a specification range for each of the plurality of variables based on each of the plurality of specifications; and
generate, by the appraisal engine, the plurality of visual representations based on a respective specification range, wherein each of the plurality of visual representations corresponds to a respective specification of the plurality of specifications.

19. The non-transitory computer readable storage media of claim 15, wherein:
the processor-executable instructions cause the one or more processors to further execute processor-executable instructions stored in the non-transitory computer readable storage media to:
generate, by the appraisal engine, an adjustment recommendation for each of the plurality of variables based on the plurality of visual representations; and
receive, from a client device, a value adjustment for a first variable of the plurality of variables based on a respective visual representation by the appraisal engine; and
the processor-executable instructions to compute, by the appraisal engine, the appraisal value of the target property based on the plurality of visual representations cause the one or more processors to further execute processor-executable instructions stored in the non-transitory computer readable storage media to:
compute, by the appraisal engine, the appraisal value of the target property based on at least one adjustment recommendation for a respective variable of the plurality of variables and the value adjustment from the client device.

20. The non-transitory computer readable storage media of claim 15, wherein the processor-executable instructions to determine, by the appraisal engine, the plurality of comparable properties based on the target property cause the one or more processors to further execute processor-executable instructions stored in the non-transitory computer readable storage media to:
determine, by the appraisal engine, a listing of properties comprising physical proximity to the target property; and
filter, by the appraisal engine, the listing of properties based on the plurality of variables to determine the plurality of comparable properties.
